(19) United States
(12) Patent Application Publication
(10) Pub. No.: US 2015/0343747 A1
(43) Pub. Date: Dec. 3, 2015

(54) POLYETHYLENE COMPOSITE MEMBERS AND METHODS FOR FORMING THE SAME

(71) Applicant: Ticona LLC, Florence, KY (US)

(72) Inventors: Christian Meermann, Sulzbach (DE); Ludger Czyborra, Sulzbach (DE); Daniel Grauer, Sulzbach (DE); Eric Folz, Sulzbach (DE)

(21) Appl. No.: 14/723,792

(22) Filed: May 28, 2015

Related U.S. Application Data
(60) Provisional application No. 62/004,574, filed on May 29, 2014.

(51) Int. Cl. B32B 27/08; B29C 65/08; B29C 70/78

(52) U.S. Cl. CPC B32B 27/08; B29C 70/78; B29C 65/08; B29L 2009/00

(57) ABSTRACT

Composite members and methods for forming composite members are provided. A composite member includes a base member, the base member formed from a polyethylene. The composite member further includes a tape bonded to the base member. The tape is formed from a fiber reinforced thermoplastic material. The fiber reinforced thermoplastic material includes a plurality of fibers dispersed in a polyethylene resin. A method includes forming a base member from a polyethylene material. The method further includes bonding a tape to the base member. The tape is formed from a fiber reinforced thermoplastic material. The fiber reinforced thermoplastic material includes a plurality of fibers dispersed in a thermoplastic resin.

### CROSS REFERENCE TO RELATED APPLICATIONS

The present application claims filing benefit of U.S. Provisional Patent Application Ser. No. 62/004,574 having a filing date of May 29, 2014 and which is incorporated by reference herein in its entirety.

### BACKGROUND OF THE INVENTION

Polymer materials have gained popularity in recent years for use in a wide variety of applications due to various advantageous characteristics. In particular, industry utilization of thermoplastics has increased as improvements in processing and forming components therefrom have been developed.

Polyethylene is an example of a thermoplastic utilized in a wide variety of applications. One particular application is the ski industry, wherein polyethylene can be utilized to form ski bases. Other applications include railway components, building materials, chemical processing equipment, watercraft, sliding components, etc. Recently high molecular weight polyethylene (HMW-PE), very-high molecular weight polyethylene (VHMW-PE) and ultra-high molecular weight polyethylene (UHMW-PE) have been utilized for such applications. These materials generally provide good abrasion and impact resistance, non-stick properties, and various mechanical characteristics.

One issue with the use of HMW-PE, VHMW-PE and UHMW-PE is the thermal expansion of semi-finished goods formed therefrom. This thermal expansion can cause installation and finishing issues with respect to the finished goods, due to inconsistent part sizes that result from the thermal expansion.

Accordingly, improved composite members, such as semi-finished members, are desired in the art. In particular, composite members which provide desired performance characteristics with decreased thermal expansion characteristics would be advantageous.

### SUMMARY OF THE INVENTION

In accordance with one embodiment of the present disclosure, a composite member is provided. The composite member includes a base member, the base member formed from a polyethylene. The composite member further includes a tape bonded to the base member. The tape is formed from a fiber reinforced thermoplastic material. The fiber reinforced thermoplastic material includes a plurality of fibers dispersed in a polyethylene resin.

In accordance with another embodiment of the present disclosure, a method for forming a composite member is provided. The method includes forming a base member from a polyethylene material. The method further includes bonding a tape to the base member. The tape is formed from a fiber reinforced thermoplastic material. The fiber reinforced thermoplastic material includes a plurality of fibers dispersed in a thermoplastic resin.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a top view of a ski formed using a composite member according to one embodiment of the present disclosure.

FIG. 2 is a top view of a composite member according to one embodiment of the present disclosure;

FIG. 3 is a top view of a composite member according to another embodiment of the present disclosure;

FIG. 4 is an exploded perspective view of an arrangement of multiple tape layers on a base member according to one embodiment of the present disclosure;

FIG. 5 is an exploded perspective view of an arrangement of multiple tape layers on a base member according to one embodiment of the present disclosure;

FIG. 6 is a schematic illustration of an impregnation system in accordance with one embodiment of the present disclosure;

FIG. 7 is a perspective view of a die in accordance with one embodiment of the present disclosure;

FIG. 8 is a cross-sectional view of the die shown in FIG. 6;

FIG. 9 is an exploded view of a manifold assembly and gate passage for a die in accordance with one embodiment of the present disclosure;

FIG. 10 is a perspective view of one embodiment of a second impregnation plate at least partially defining an impregnation zone in accordance with one embodiment of the present disclosure;

FIG. 11 is a close-up cross-sectional view of a portion of an impregnation zone in accordance with one embodiment of the present disclosure;

FIG. 12 is a close-up cross-sectional view of a downstream end portion of an impregnation zone in accordance with one embodiment of the present disclosure;

FIG. 13 is a perspective view of a land zone in accordance with one embodiment of the present disclosure;

FIG. 14 is a perspective view of a land zone in accordance with one embodiment of the present disclosure;

FIG. 15 is a perspective view of a tape in accordance with one embodiment of the present disclosure;

FIG. 16 is a cross-sectional view of a tape in accordance with one embodiment of the present disclosure;

FIG. 17 is a perspective view of a mold utilized to form a composite member in accordance with one embodiment of the present disclosure;

FIG. 18 is a perspective view of a mold utilized to form a composite member in accordance with another embodiment of the present disclosure; and

FIG. 19 is a perspective view of a welding device utilized to form a composite member in accordance with one embodiment of the present disclosure.

Repeat use of reference characters in the present specification and drawings is intended to represent the same or analogous features or elements of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

“High molecular weight polyethylene” (“HMW-PE”) refers to polyethylene compositions with weight-average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” (“VHMW-PE”) refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” (“UHMW-PE”) refers to polyethylene compositions with weight-average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

“High density polyethylene” (“HDPE”) refers to polyethylene compositions having densities between about 0.93 g/cm³ and about 0.97 g/cm³, or between about 0.941 g/cm³ and about 0.965 g/cm³.

The present disclosure is generally directed to composite members. A composite member according to the present disclosure generally includes a base member formed from a polyethylene material, such as HMW-PE, VHMW-PE or UHMW-PE. Additionally, one or more tapes are bonded to the base member. The tapes in exemplary embodiments provide localized reinforcement of the base member, reinforcing the base member at the particular locations where the tapes are bonded to the base member. A tape in exemplary embodiments may be formed from a fiber reinforced thermoplastic material which includes a polyethylene resin, such as high density polyethylene (HDPE). Alternatively, use of any suitable fiber reinforced thermoplastic material is within the scope and spirit of the present disclosure.

The use of tapes according to the present disclosure to reinforce polyethylene base members provides the resulting composite members with a variety of advantageous characteristics. For example, the addition of such tapes may reduce the thermal expansion of the resulting members or allow tailoring and control over such thermal expansion. For example, the tapes can be located relative to the base members such that thermal expansion is reduced in a specified direction or orientation. Further, the addition of such tapes increases, for example, the strength (such as bending strength and/or elongational strength in particular), stiffness, and localized impact resistance of the composite members. The tapes can, for example, be located relative to the base members in areas that, for the resulting member, will experience high impacts, thus locally reinforcing these areas. Additionally, in the specific application of ski bases, the addition of tapes to base members according to the present disclosure to form composite members allows for the production of ski bases which do not require the additional use of phenolic or epoxy duromeric plastics. This reduces the time and expense associated with such production.

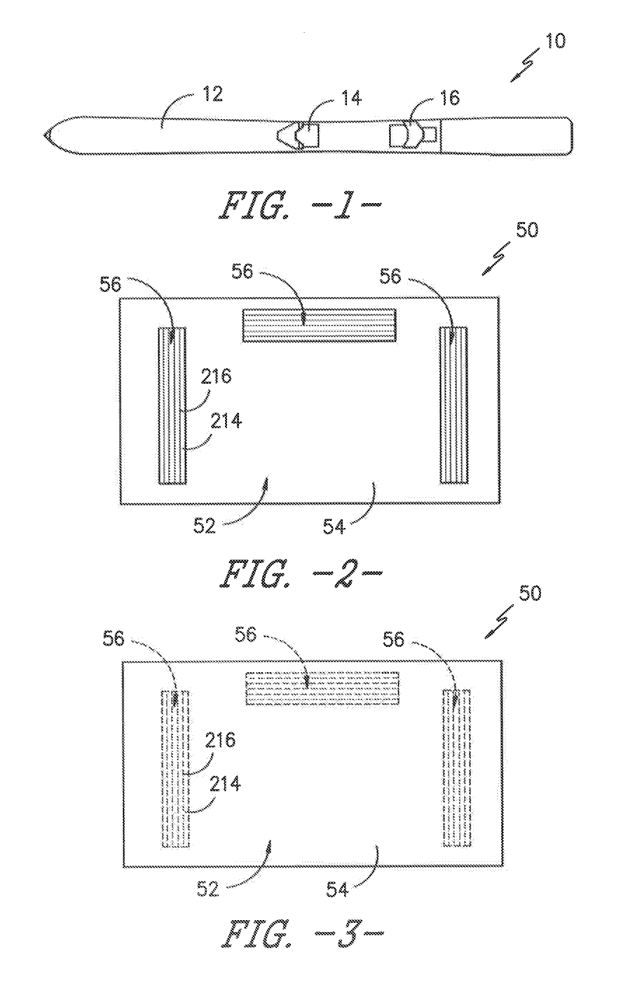

Referring now to FIG. 1, an exemplary ski 10 is illustrated. The ski 10 includes a ski base 12, which in exemplary embodiments may be formed from a composite member 50 in accordance with the present disclosure. The composite member 50 may, for example, be the finished ski base 12, or may be a semi-finished product that is further processed and finished to form the ski base 12. Ski base 12 may additionally include other various components, such as a front binding 14 and a rear binding 16.

It should be understood that the present disclosure is not limited to the use of composite members 50 in ski bases 12. Rather, any suitable use of a composite member 50 in any industry as a finished or semi-finished product is within the scope and spirit of the present disclosure. Other applications include railway components (e.g. cover parts which are desirably drop and scratch resistant), building materials, chemical processing equipment, watercraft (e.g. outer components which contact the water, and which have desirably reduced contact forces), sliding components (e.g. for any suitable surface, including snow, ice, concrete, wood, mud, soil, metal, sand, etc.), etc.

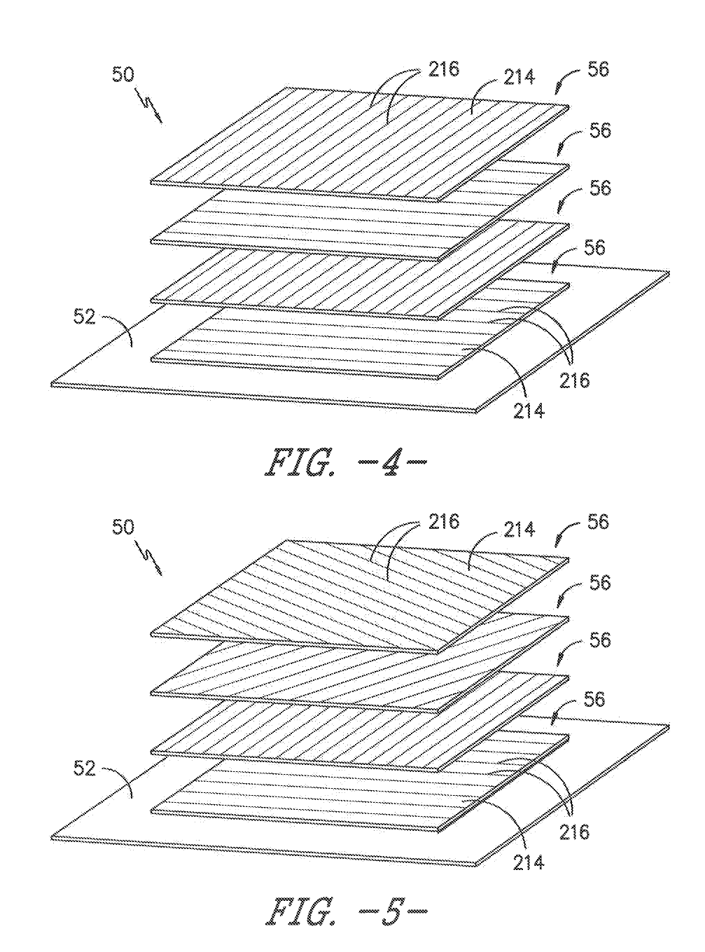

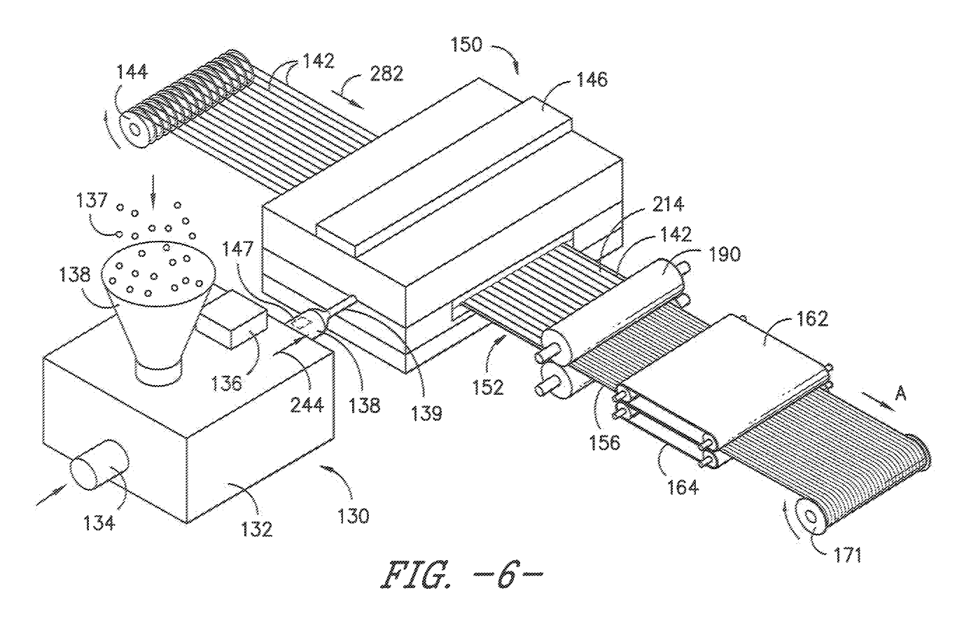

FIGS. 2 and 3 illustrate exemplary composite members 50. As discussed, a composite member 50 in some embodiments is a semi-finished product, which may thus be further processed and finished to form a finished product. In other embodiments, the composite member 50 is a finished product.

A composite member 50 includes a base member 52, which is formed from a polyethylene. The polyethylene may, for example, be HMW-PE, VHMW-PE or UHMW-PE. In some embodiments, the base member 52 consists essentially of polyethylene (and thus may include various binders, additives, etc.). The base member 52 may have any suitable size and shape, as required for a desired application, and may generally include an outer surface 54. The base member 52 may be, for example, a sheet as shown, or another suitable member such as a rod or profile. Further, the base member 52 may in some embodiments be a semi-finished product or a finished product, as desired.

A composite member 50 further includes one or more tapes 56 which are bonded to the base member 52. In some embodiments, one or more tapes 56 may be bonded to the outer surface 54 of the base member 52, as illustrated in FIG. 2. The tapes 56 may, for example, be bonded to the outer surface 54 through thermoforming, use of a static press, compression molding, injection molding, welding, or other suitable methods. In other embodiments, as illustrated in FIG. 3, one or more tapes 56 may be disposed within and thus bonded internally with the base member 52. The tapes 56 may, for example, be bonded within the base member 52 by compression molding, injection molding, or other suitable methods.

As illustrated, the tapes 56 may in exemplary embodiments provide local reinforcement to the base member 52. The tapes 56 are thus positioned relative to the base member 52 and bonded to the base member 52 at specified areas of the base member 52, which are generally smaller than the overall surface area of the base member 52, to reinforce these particular areas.

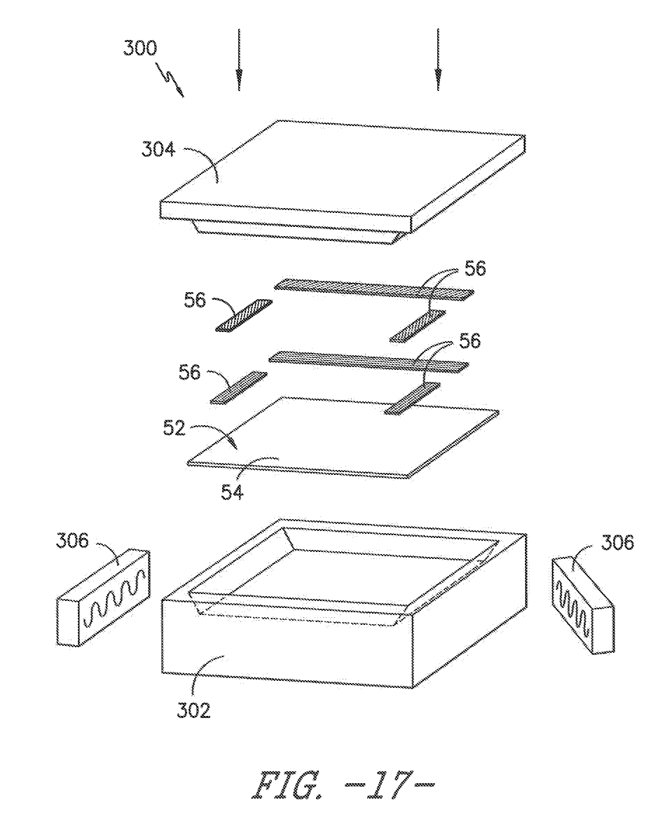

Referring to FIGS. 15 and 16, a tape 56 in accordance with the present disclosure is formed from a fiber reinforced thermoplastic material, which generally includes a plurality of fibers 216 dispersed in a thermoplastic resin 214. The resin 214 utilized in the fiber reinforced thermoplastic material in exemplary embodiments is a polyethylene resin, such as HDPE. Alternatively, suitable thermoplastics may include, for instance, polyolefins (e.g., polypropylene, propylene-ethylene copolymers, etc.), polyesters (e.g., polybutylene terephalate (“PBT”)), polycarbonates, polyamides (e.g., Nylon™), polyether ketones (e.g., polyetherether ketone (“PEEK”)), polyetherimides, polyarylene ketones (e.g., polyphenylene diketone (“PPDK”)), liquid crystal polymers, polyarylene sulfides (e.g., polyphenylene sulfide (“PPS”)), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes, polycarbonates, styrenic polymers (e.g., acrylonitrile butadiene styrene (“ABS”)), and so forth.

A plurality of fibers 216 are embedded and dispersed in the resin 214 to reinforce the resin 214 and resulting tape 56. In exemplary embodiments, the fibers 216 are continuous fibers, as illustrated, although the fiber reinforced thermoplastic material may additionally or alternatively include long fibers therein. The fibers may be dispersed in the resin 214 to form the fiber reinforced thermoplastic material. As used herein, the term “long fibers” generally refers to fibers, filaments, yarns, or rovings that are not continuous, and as opposed to “continuous fibers” which generally refer to fibers, filaments, yarns, or rovings having a length that is generally limited only by the length of a part. The fibers dispersed in the resin may be formed from any conventional material known in the art, such as metal fibers, glass fibers (e.g., E-glass, A-glass, C-glass, D-glass, AR-glass, R-glass, S-glass such as S1-glass or S2-glass), carbon fibers (e.g., graphite), boron fibers, ceramic fibers (e.g., alumina or silica), aramid fibers (e.g., Kevlar® marketed by E. I. duPont de Nemours, Wilmington, Del.), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing polymer compositions. Glass fibers and carbon fibers, as well as aramid fibers, are particularly desirable. In exemplary embodiments as illustrated, the fibers 216 may be continuous fibers which are generally unidirectional.

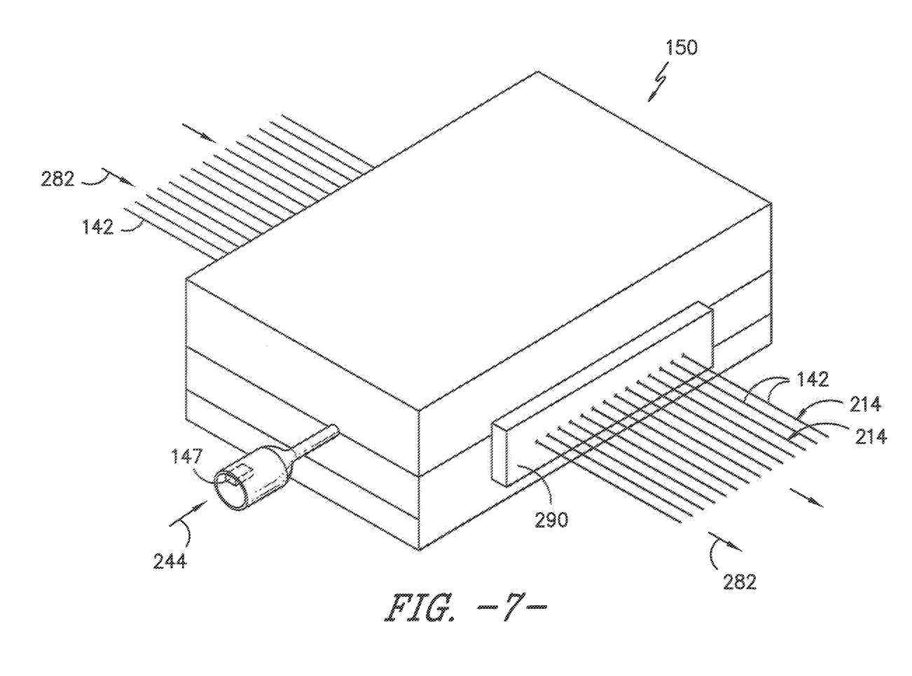

As discussed, a plurality of tapes 56 may be bonded to a base member 52. Further, in some embodiments, the plurality of tapes 56 or a portion thereof may be arranged as a plurality of layers of tapes 56 at one or more locations on a base member 52. For example, referring to FIGS. 4 and 5, multiple layers of tapes 56 may be bonded to a base member 52 at a specific location on the base member 52. A first tape 56 layer may be bonded directly to the base member 52, and one or more additional tape 56 layers may be bonded indirectly to the base member 52 through the directly bonded tape 56 layer, as illustrated. Further, the fibers 216 in each tape 56 layer may have any suitable orientation. As discussed above, in exemplary embodiments, the fibers 216 may be continuous fibers which are generally unidirectional. In some embodiments, as illustrated in FIG. 4, successive tape layers may have a 0 degree/90 degree orientation. In other embodiments, as illustrated in FIG. 5, successive tape layers may have a 0 degree/90 degree/45 degree/−45 degree orientation. In still other embodiments, 45 degree/−45 degree orientations, 0 degree/45 degree/−45 degree orientation, and/or any other suitable orientations may be utilized.

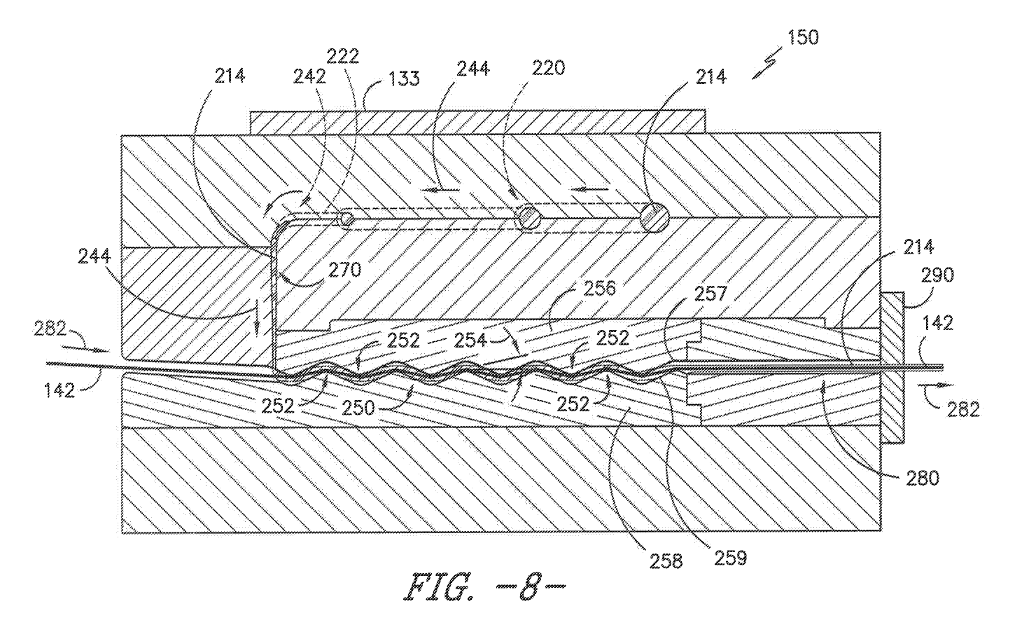

Exemplary embodiments of suitable processes and apparatus, such as pultrusion processes and apparatus, for forming a tape 56 according to the present disclosure are provided herein. Referring to FIG. 6, one embodiment of such an extrusion device is shown. More particularly, the apparatus includes an extruder 130 containing a screw shaft 134 mounted inside a barrel 132. A heater 136 (e.g., electrical resistance heater) is mounted outside the barrel 132. During use, a feedstock 137 is supplied to the extruder 130 through a hopper 138. The feedstock is formed from a thermoplastic material as discussed above. The feedstock 137 is conveyed inside the barrel 132 by the screw shaft 134 and heated by frictional forces inside the barrel 132 and by the heater 136. Upon being heated, the feedstock 137 exits the barrel 132 through a barrel flange 138 and enters a die flange 139 of an impregnation die 150.

A continuous fiber roving 142 or a plurality of continuous fiber rovings 142 are supplied from a reel or reels 144 to die 150. Each roving 142 may include a plurality of fibers 216, as discussed herein. The rovings 142 are generally positioned side-by-side, with minimal to no distance between neighboring rovings, before impregnation. The feedstock 137 may further be heated inside the die by heaters 146 mounted in or around the die 150. The die is generally operated at temperatures that are sufficient to cause and/or maintain the proper melt temperature for the thermoplastic material, thus allowing for the desired level of impregnation of the rovings by the thermoplastic material. Typically, the operation temperature of the die is higher than the melt temperature of the thermoplastic material, such as at temperatures from about 135° C. to about 450′C. When processed in this manner, the continuous fiber rovings 142 become embedded in the thermoplastic material, which may be a resin 214 processed from the feedstock 137. The mixture may then exit the impregnation die 150 as wetted composite, extrudate, or tape 56.

As used herein, the term “roving” generally refers to a bundle of individual fibers 216. The fibers 216 contained within the roving can be twisted or can be straight. The rovings may contain a single fiber type or different types of fibers 216. Different fibers may also be contained in individual rovings or, alternatively, each roving may contain a different fiber type. The fibers employed in the rovings possess a high degree of tensile strength relative to their mass. For example, the ultimate tensile strength of the fibers is typically from about 1,000 to about 15,000 Megapascals (“MPa”), in some embodiments from about 2,000 MPa to about 10,000 MPa, and in some embodiments, from about 3,000 MPa to about 6,000 MPa. Such tensile strengths may be achieved even though the fibers are of a relatively light weight, such as a mass per unit length of from about 0.05 to about 2 grams per meter, in some embodiments from about 0.4 to about 1.5 grams per meter. The ratio of tensile strength to mass per unit length may thus be about 1,000 Megapascals per gram per meter (“MPa/g/m”) or greater, in some embodiments about 4,000 MPa/g/m or greater, and in some embodiments, from about 5,500 to about 20,000 MPa/g/m. Carbon fibers are particularly suitable for use as the fibers, which typically have a tensile strength to mass ratio in the range of from about 5,000 to about 7,000 MPa/g/m. The fibers often have a nominal diameter of about 4 to about 35 micrometers, and in some embodiments, from about 9 to about 35 micrometers. The number of fibers contained in each roving can be constant or vary from roving to roving. Typically, a roving contains from about 1,000 fibers to about 50,000 individual fibers, and in some embodiments, from about 5,000 to about 30,000 fibers.

A pressure sensor 147 may sense the pressure near the impregnation die 150 to allow control to be exerted over the rate of extrusion by controlling the rotational speed of the screw shaft 134, or the feed rate of the feeder. That is, the pressure sensor 147 is positioned near the impregnation die 150, such as upstream of the manifold assembly 220, so that the extruder 130 can be operated to deliver a correct amount of resin 214 for interaction with the fiber rovings 142. After leaving the impregnation die 150, impregnated rovings 142 or the extrudate or tape 56, which may comprises the fiber reinforced thermoplastic material, may enter an optional pre-shaping or guiding section (not shown) and/or a preheating device to control the temperature of the extrudate before entering a nip formed between two adjacent rollers 190. Although optional, the rollers 190 can help to consolidate the impregnated rovings 142 into a tape 56 or generally consolidate the tape 56, as well as enhance fiber impregnation and squeeze out any excess voids. In addition to the rollers 190, other shaping devices may also be employed, such as a die system. Regardless, the resulting consolidated tape 56 may be pulled by tracks 162 and 164 mounted on rollers. The tracks 162 and 164 also pull the impregnated rovings 142 or tape 56 from the impregnation die 150 and through the rollers 190. If desired, the consolidated tape 56 may be wound up at a section 171. Generally speaking, the resulting tapes are relatively thin and typically have a thickness of from about 0.05 to about 1 millimeter, in some embodiments from about 0.1 to about 0.8 millimeters, and in some embodiments, from about 0.1 to about 0.4 millimeters.

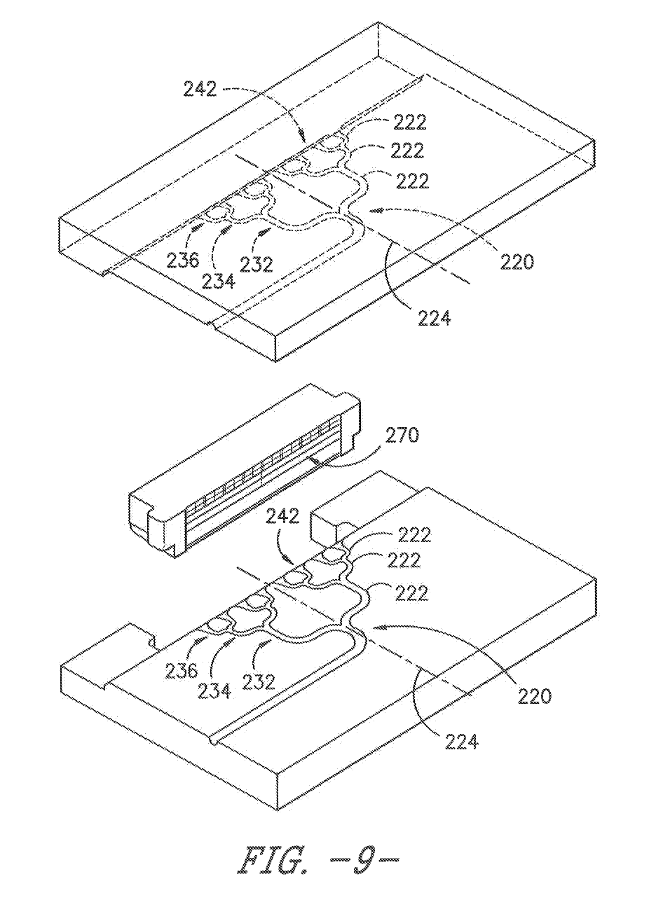

Perspective views of one embodiment of a die 150 according to the present disclosure are further shown in FIGS. 6 and 7. As shown, resin 214 is flowed into the die 150 as indicated by resin flow direction 244. The resin 214 is distributed within the die 150 and then interacted with the rovings 142. The rovings 142 are traversed through the die 150 in roving run direction 282, and are coated with resin 214. The rovings 142 are then impregnated with the resin 214, and these impregnated rovings 142 exit the die 150. In some embodiments, as shown in FIG. 6, the impregnated rovings 142 are connected by the resin 214 and thus exit as tape 56. In other embodiments, as shown in FIGS. 7 and 8, the impregnated rovings 142 exit the die separately, each impregnated within resin 214.

Within the impregnation die, it is generally desired that the rovings 142 are traversed through an impregnation zone 250 to impregnate the rovings with the polymer resin 214. In the impregnation zone 250, the polymer resin may be forced generally transversely through the rovings by shear and pressure created in the impregnation zone 250, which significantly enhances the degree of impregnation. This is particularly useful when forming a composite from tapes of high fiber content, such as about 35% weight fraction (“Wf”) or more, and in some embodiments, from about 40% Wf or more. Typically, the die 150 will include a plurality of contact surfaces 252, such as for example at least 2, at least 3, from 4 to 7, from 2 to 20, from 2 to 30, from 2 to 40, from 2 to 50, or more contact surfaces 252, to create a sufficient degree of penetration and pressure on the rovings 142. Although their particular form may vary, the contact surfaces 252 typically possess a curvilinear surface, such as a curved lobe, pin, etc. The contact surfaces 252 are also typically made of a metal material.

FIG. 8 shows a cross-sectional view of an impregnation die 150. As shown, the impregnation die 150 includes a manifold assembly 220 and an impregnation section. The impregnation section includes an impregnation zone 250. In some embodiments, the impregnation section additionally includes a gate passage 270. The manifold assembly 220 is provided for flowing the polymer resin 214 therethrough. For example, the manifold assembly 220 may include a channel 222 or a plurality of channels 222. The resin 214 provided to the impregnation die 150 may flow through the channels 222.

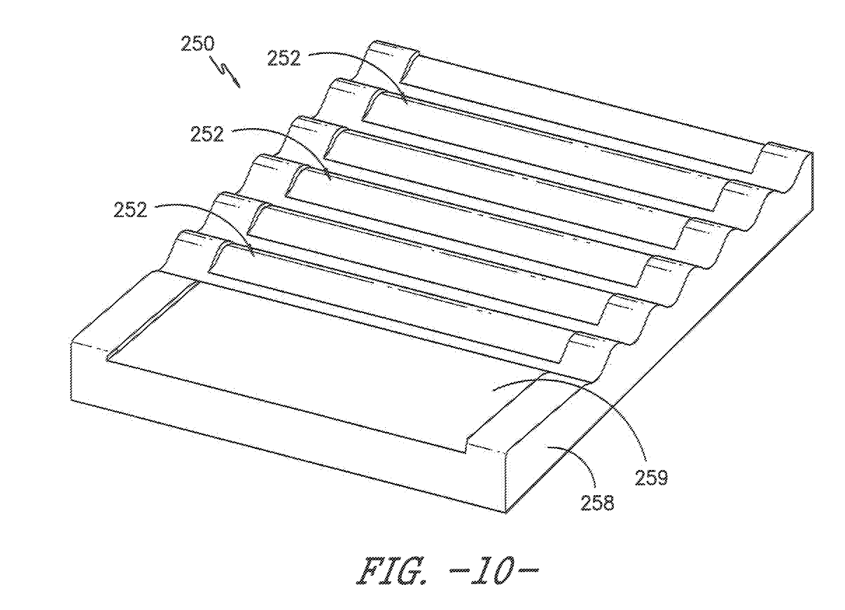

As shown in FIG. 9, in exemplary embodiments, at least a portion of each of the channels 222 may be curvilinear. The curvilinear portions may allow for relatively smooth redirection of the resin 214 in various directions to distribute the resin 214 through the manifold assembly 220, and may allow for relatively smooth flow of the resin 214 through the channels 222. Alternatively, the channels 222 may be linear, and redirection of the resin 214 may be through relatively sharp transition areas between linear portions of the channels 222. It should further be understood that the channels 222 may have any suitable shape, size, and/or contour.

The plurality of channels 222 may, in exemplary embodiments as shown in FIG. 9, be a plurality of branched runners 222. The runners 222 may include a first branched runner group 232. The first branched runner group 232 includes a plurality of runners 222 branching off from an initial channel or channels 222 that provide the resin 214 to the manifold assembly 220. The first branched runner group 232 may include 2, 3, 4 or more runners 222 branching off from the initial channels 222.

If desired, the runners 222 may include a second branched runner group 234 diverging from the first branched runner group 232, as shown. For example, a plurality of runners 222 from the second branched runner group 234 may branch off from one or more of the runners 222 in the first branched runner group 232. The second branched runner group 234 may include 2, 3, 4 or more runners 222 branching off from runners 222 in the first branched runner group 232.

If desired, the runners 222 may include a third branched runner group 236 diverging from the second branched runner group 234, as shown. For example, a plurality of runners 222 from the third branched runner group 236 may branch off from one or more of the runners 222 in the second branched runner group 234. The third branched runner group 236 may include 2, 3, 4 or more runners 222 branching off from runners 222 in the second branched runner group 234.

In some exemplary embodiments, as shown, the plurality of branched runners 222 has a symmetrical orientation along a central axis 224. The branched runners 222 and the symmetrical orientation thereof generally evenly distribute the resin 214, such that the flow of resin 214 exiting the manifold assembly 220 and coating the rovings 142 is substantially uniformly distributed on the rovings 142. This desirably allows for generally uniform impregnation of the rovings 142.

Further, the manifold assembly 220 may in some embodiments define an outlet region 242. The outlet region 242 is that portion of the manifold assembly 220 wherein resin 214 exits the manifold assembly 220. Thus, the outlet region 242 generally encompasses at least a downstream portion of the channels or runners 222 from which the resin 214 exits. In some embodiments, as shown, at least a portion of the channels or runners 222 disposed in the outlet region 242 have an increasing area in a flow direction 244 of the resin 214. The increasing area allows for diffusion and further distribution of the resin 214 as the resin 214 flows through the manifold assembly 220, which further allows for substantially uniform distribution of the resin 214 on the rovings 142. Additionally or alternatively, various channels or runners 222 disposed in the outlet region 242 may have constant areas in the flow direction 244 of the resin 214, or may have decreasing areas in the flow direction 244 of the resin 214.

In some embodiments, as shown, each of the channels or runners 222 disposed in the outlet region 242 is positioned such that resin 214 flowing therefrom is combined with resin 214 from other channels or runners 222 disposed in the outlet region 242. This combination of the resin 214 from the various channels or runners 222 disposed in the outlet region 242 produces a generally singular and uniformly distributed flow of resin 214 from the manifold assembly 220 to substantially uniformly coat the rovings 142. Alternatively, some of the channels or runners 222 disposed in the outlet region 242 may be positioned such that resin 214 flowing therefrom is discrete from the resin 214 from other channels or runners 222 disposed in the outlet region 242. In these embodiments, a plurality of discrete but generally evenly distributed resin flows 214 may be produced by the manifold assembly 220 for substantially uniformly coating the rovings 142.

As shown in FIG. 8, at least a portion of the channels or runners 222 disposed in the outlet region 242 have curvilinear cross-sectional profiles. These curvilinear profiles allow for the resin 214 to be gradually directed from the channels or runners 222 generally downward towards the rovings 142. Alternatively, however, these channels or runners 222 may have any suitable cross-sectional profiles.

As further illustrated in FIGS. 8 and 9, after flowing through the manifold assembly 220, the resin 214 may flow through gate passage 270. Gate passage 270 is positioned between the manifold assembly 220 and the impregnation zone 250, and is provided for flowing the resin 214 from the manifold assembly 220 such that the resin 214 coats the rovings 142. Thus, resin 214 exiting the manifold assembly 220, such as through outlet region 242, may enter gate passage 270 and flow therethrough.

In some embodiments, as shown in FIG. 8, the gate passage 270 extends vertically between the manifold assembly 220 and the impregnation zone 250. Alternatively, however, the gate passage 270 may extend at any suitable angle between vertical and horizontal such that resin 214 is allowed to flow therethrough.

Further, as shown in FIG. 8, in some embodiments at least a portion of the gate passage 270 has a decreasing cross-sectional profile in the flow direction 244 of the resin 214. This taper of at least a portion of the gate passage 270 may increase the flow rate of the resin 214 flowing therethrough before it contacts the rovings 142, which may allow the resin 214 to impinge on the rovings 142. Initial impingement of the rovings 142 by the resin 214 provides for further impregnation of the rovings, as discussed below. Further, tapering of at least a portion of the gate passage 270 may increase backpressure in the gate passage 270 and the manifold assembly 220, which may further provide more even, uniform distribution of the resin 214 to coat the rovings 142. Alternatively, the gate passage 270 may have an increasing or generally constant cross-sectional profile, as desired or required.

Upon exiting the manifold assembly 220 and the gate passage 270 of the die 150 as shown in FIG. 8, the resin 214 contacts the rovings 142 being traversed through the die 150. As discussed above, the resin 214 may substantially uniformly coat the rovings 142, due to distribution of the resin 214 in the manifold assembly 220 and the gate passage 270. Further, in some embodiments, the resin 214 may impinge on an upper surface of each of the rovings 142, or on a lower surface of each of the rovings 142, or on both an upper and lower surface of each of the rovings 142. Initial impingement on the rovings 142 provides for further impregnation of the rovings 142 with the resin 214. Impingement on the rovings 142 may be facilitated by the velocity of the resin 214 when it impacts the rovings 142, the proximity of the rovings 142 to the resin 214 when the resin exits the manifold assembly 220 or gate passage 270, or other various variables.

As shown in FIG. 8, the coated rovings 142 are traversed in run direction 282 through impregnation zone 250. The impregnation zone 250 is in fluid communication with the manifold assembly 220, such as through the gate passage 270 disposed therebetween. The impregnation zone 250 is configured to impregnate the rovings 142 with the resin 214.

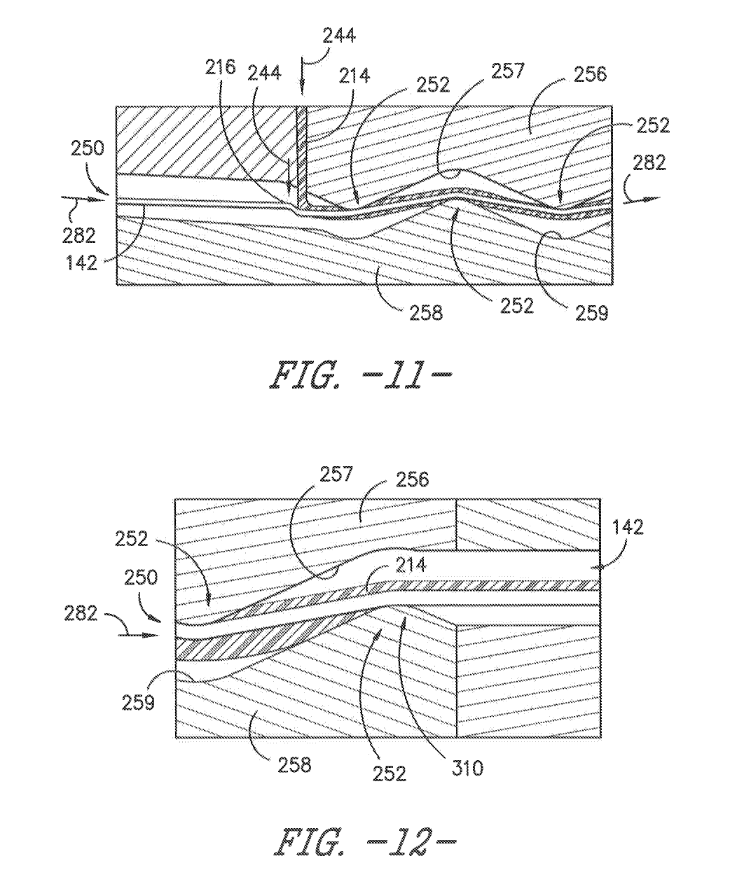

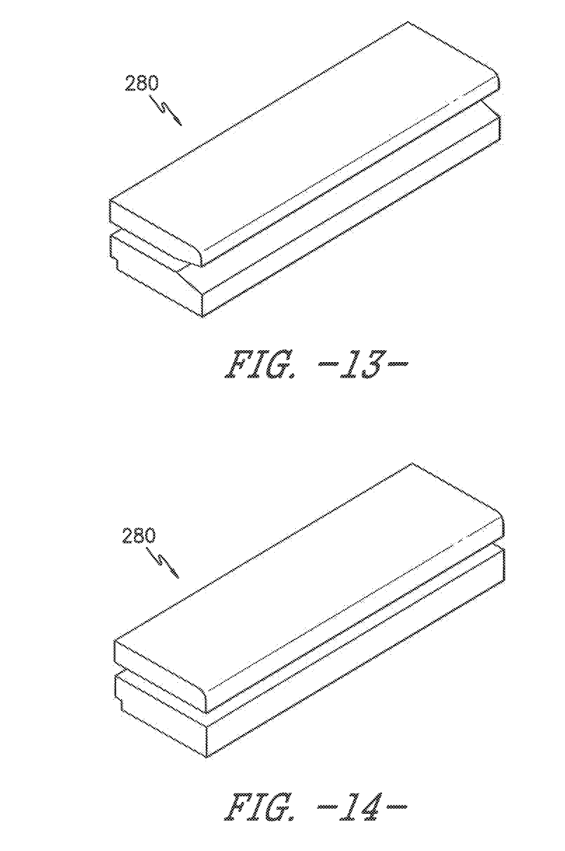

For example, as discussed above, in exemplary embodiments as shown in FIGS. 8 and 10 through 12, the impregnation zone 250 includes a plurality of contact surfaces 252. The rovings 142 are traversed over the contact surfaces 252 in the impregnation zone. Impingement of the rovings 142 on the contact surface 252 creates shear and pressure sufficient to impregnate the rovings 142 with the resin 214 coating the rovings 142.

In some embodiments, as shown in FIGS. 8, 11 and 12, the impregnation zone 250 is defined between two spaced apart opposing impregnation plates 256 and 258, which may be included in the impregnation section. First plate 256 defines a first inner surface 257, while second plate 258 defines a second inner surface 259. The impregnation zone 250 is defined between the first plate 256 and the second plate 258. The contact surfaces 252 may be defined on or extend from both the first and second inner surfaces 257 and 259, or only one of the first and second inner surfaces 257 and 259.

In exemplary embodiments, as shown in FIGS. 8, 11 and 12, the contact surfaces 252 may be defined alternately on the first and second surfaces 257 and 259 such that the rovings alternately impinge on contact surfaces 252 on the first and second surfaces 257 and 259. Thus, the rovings 142 may pass contact surfaces 252 in a waveform, tortuous or sinusoidal-type pathway, which enhances shear.

Angle 254 at which the rovings 142 traverse the contact surfaces 252 may be generally high enough to enhance shear and pressure, but not so high to cause excessive forces that will break the fibers. Thus, for example, the angle 254 may be in the range between approximately 1° and approximately 30°, and in some embodiments, between approximately 5° and approximately 25°.

As stated above, contact surfaces 252 typically possess a curvilinear surface, such as a curved lobe, pin, etc. In exemplary embodiments as shown, a plurality of peaks, which may form contact surfaces 252, and valleys are thus defined. Further, in many exemplary embodiments, the impregnation zone 250 has a waveform cross-sectional profile. In one exemplary embodiment as shown in FIGS. 8 and 10 through 12, the contact surfaces 252 are lobes that form portions of the waveform surfaces of both the first and second plates 256 and 258 and define the waveform cross-sectional profile. FIG. 10 illustrates the second plate 258 and the various contact surfaces thereon that form at least a portion of the impregnation zone 250 according to some of these embodiments.

In other embodiments, the contact surfaces 252 are lobes that form portions of a waveform surface of only one of the first or second plate 256 or 258. In these embodiments, impingement occurs only on the contact surfaces 252 on the surface of the one plate. The other plate may generally be flat or otherwise shaped such that no interaction with the coated rovings occurs.

In other alternative embodiments, the impregnation zone 250 may include a plurality of pins (or rods), each pin having a contact surface 252. The pins may be static, freely rotational (not shown), or rotationally driven. Further, the pins may be mounted directly to the surface of the plates defining the impingement zone, or may be spaced from the surface. It should be noted that the pins may be heated by heaters 143, or may be heated individually or otherwise as desired or required. Further, the pins may be contained within the die 150, or may extend outwardly from the die 150 and not be fully encased therein.

In further alternative embodiments, the contact surfaces 252 and impregnation zone 250 may comprise any suitable shapes and/or structures for impregnating the rovings 142 with the resin 214 as desired or required.

As discussed, a roving 142 traversed through an impregnation zone 250 according to the present disclosure may become impregnated by resin 214, thus resulting in an impregnated roving 142, and optionally a tape 152 comprising at least one roving 142, exiting the impregnation zone 250, such as downstream of the contact surfaces 252 in the run direction 282. The impregnated rovings 142 and optional tape 152 exiting the impregnation zone 250 are thus formed from a fiber impregnated polymer material, as discussed above.

As further shown in FIGS. 7 and 8, in some embodiments, a faceplate 290 may adjoin or be adjacent to the impregnation zone 250. The faceplate 290 may be positioned downstream of the impregnation zone 250 and, if included, the land zone 280, in the run direction 282. The faceplate 290 may contact other components of the die 150, such as the impregnation zone 250 or land zone 280, or may be spaced therefrom. Faceplate 290 is generally configured to meter excess resin 214 from the rovings 142. Thus, apertures in the faceplate 290, through which the rovings 142 traverse, may be sized such that when the rovings 142 are traversed therethrough, the size of the apertures causes excess resin 214 to be removed from the rovings 142.

As shown in FIG. 6, in alternative embodiments, the die 150 may lack a faceplate 290. Further, in some embodiments, the formation and maintenance of a tape 56 within and exited from a die 150 of the present disclosure may be facilitated through the lack of or removal of a faceplate from the die 150. Removal of the faceplate 290 allows for a plurality of rovings 142 exiting a die 150 to exit as a single tape 56, rather than as separated rovings 142 due to metering through the faceplate. This could potentially eliminate the need to later form these rovings 142 into such a tape 56. Removal of the faceplate 290 may have additional advantages. For example, removal may prevent clogging of the faceplate with resin 214, which can disrupt the traversal of rovings 142 therethrough. Additionally, removal may allow for easier access to the impregnation zone 250, and may thus make it easier to introduce and reintroduce rovings 142 to the impregnation zone 250 during start-up, after temporary disruptions such as due to breakage of a roving 142, or during any other suitable time period.

It should be understood that a tape 56 according to the present disclosure may have any suitable cross-sectional shape and/or size. For example, such tape 56 may have a generally rectangular shape, or a generally oval or circular or other suitable polygonal or otherwise shape. Further, it should be understood that one or more impregnated rovings 142 having been traversed through the impregnation zone 250 may together form the tape 56, with the resin 214 of the various rovings 142 connected to form such tape 56. The various above amounts, ranges, and/or ratios may thus in exemplary embodiments be determined for a tape 56 having any suitable number of impregnated rovings 142 and fibers 216 thereof embedded and generally dispersed within resin 214.

To further facilitate impregnation of the rovings 142, they may also be kept under tension while present within the die 150, and specifically within the impregnation zone 250. The tension may, for example, range from about 5 to about 300 Newtons, in some embodiments from about 50 to about 250 Newtons, and in some embodiments, from about 100 to about 200 Newtons per roving 142 or tow of fibers.

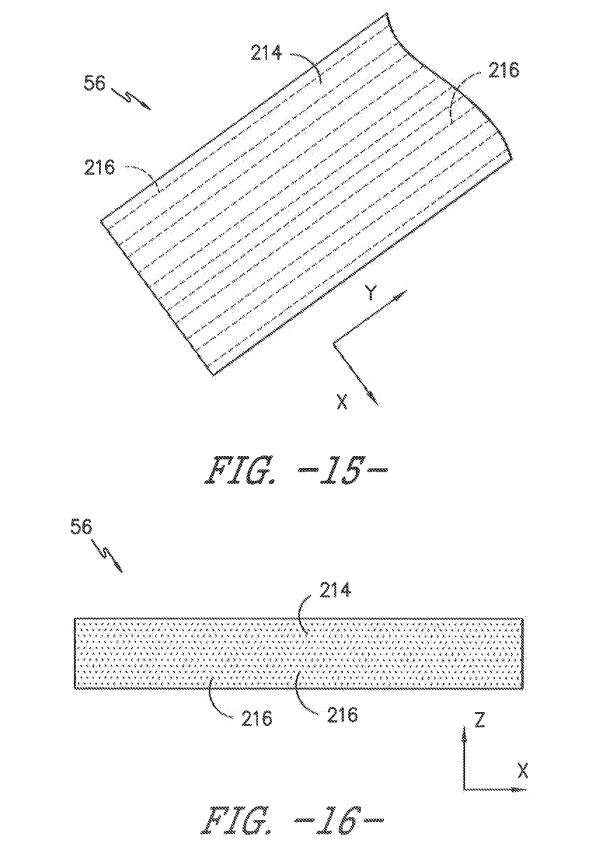

As shown in FIGS. 13 and 14, in some embodiments, a land zone 280 may be positioned downstream of the impregnation zone 250 in run direction 282 of the rovings 142. The rovings 142 may traverse through the land zone 280 before exiting the die 150. In some embodiments, as shown in FIG. 13, at least a portion of the land zone 280 may have an increasing cross-sectional profile in run direction 282, such that the area of the land zone 280 increases. The increasing portion may be the downstream portion of the land zone 280 to facilitate the rovings 142 exiting the die 150. Alternatively, the cross-sectional profile or any portion thereof may decrease, or may remain constant as shown in FIG. 14.

Additionally, other components may be optionally employed to assist in the impregnation of the fibers. For example, a “gas jet” assembly may be employed in certain embodiments to help uniformly spread a roving of individual fibers, which may each contain up to as many as 24,000 fibers, across the entire width of the merged tow. This helps achieve uniform distribution of strength properties. Such an assembly may include a supply of compressed air or another gas that impinges in a generally perpendicular fashion on the moving rovings that pass across exit ports. The spread rovings may then be introduced into a die for impregnation, such as described above.

It should be understood that tapes 56 and impregnated rovings 142 thereof according to the present disclosure need not be formed in the dies 150 and other apparatus as discussed above. Such dies 150 and apparatus are merely disclosed as examples of suitable equipment for forming tapes 56. The use of any suitable equipment or process to form tapes 56 is within the scope and spirit of the present disclosure.

A relatively high percentage of fibers 216 may be employed in a tape 56, and fiber reinforced thermoplastic material thereof, to provide enhanced strength properties. For instance, fibers typically constitute from about 25 wt. % to about 90 wt. %, in some embodiments from about 30 wt. % to about 75 wt. %, and in some embodiments, from about 35 wt. % to about 70 wt. % of the tape or material thereof. Likewise, polymer(s) typically constitute from about 20 wt. % to about 75 wt. %, in some embodiments from about 25 wt. % to about 70 wt. %, and in some embodiments, from about 30 wt. % to about 65 wt. % of the tape 56. Such percentage of fibers may additionally or alternatively be measured as a volume fraction. For example, in some embodiments, the fiber reinforced thermoplastic material may have a fiber volume fraction between approximately 25% and approximately 80%, in some embodiments between approximately 30% and approximately 70%, in some embodiments between approximately 40% and approximately 60%, and in some embodiments between approximately 45% and approximately 55%.

The tapes 56 that result from use of dies and methods according to the present disclosure may have a very low void fraction, which helps enhance their strength. For instance, the void fraction may be about 5% or less, in some embodiments about 4% or less, in some embodiments about 3% or less, in some embodiments about 2% or less, in some embodiments about 1.5% or less, in some embodiments about 1% or less, and in some embodiments, about 0.5% or less. The void fraction may be measured using techniques well known to those skilled in the art. For example, the void fraction may be measured using a “resin burn off” test in which samples are placed in an oven (e.g., at 600° C. for 3 hours) to burn out the resin. The mass of the remaining fibers may then be measured to calculate the weight and volume fractions. Such “burn off” testing may be performed in accordance with ASTM D 2584-08 to determine the weights of the fibers and the polymer matrix, which may then be used to calculate the “void fraction” based on the following equations:

V_{f}=100*(ρₜ−ρ_{c})/ρₜ

where,

V_{f} is the void fraction as a percentage;

ρ_{c} is the density of the composite as measured using known techniques, such as with a liquid or gas pycnometer (e.g., helium pycnometer);

ρₜ is the theoretical density of the composite as is determined by the following equation:

ρₜ=1/[W_{f}/ρ_{f}+Wₘ/ρₘ]

ρₘ is the density of the polymer matrix (e.g., at the appropriate crystallinity);

ρ_{f} is the density of the fibers;

W_{f} is the weight fraction of the fibers; and

Wₘ is the weight fraction of the polymer matrix.

Alternatively, the void fraction may be determined by chemically dissolving the resin in accordance with ASTM D 3171-09. The “burn off” and “dissolution” methods are particularly suitable for glass fibers, which are generally resistant to melting and chemical dissolution. In other cases, however, the void fraction may be indirectly calculated based on the densities of the polymer, fibers, tape, etc. in accordance with ASTM D 2734-09 (Method A), where the densities may be determined ASTM D792-08 Method A. Of course, the void fraction can also be estimated using conventional microscopy equipment.

As discussed above, after exiting an impregnation die 150, the fiber reinforced thermoplastic material may in some embodiments form a tape 56. The number of rovings employed in each tape 56 may vary. Typically, however, a tape 56 will contain from 2 to 80 rovings, and in some embodiments from 10 to 60 rovings, and in some embodiments, from 20 to 50 rovings. In some embodiments, it may be desired that the rovings are spaced apart approximately the same distance from each other within the tape 56. In other embodiments, however, it may be desired that the rovings are combined, such that the fibers of the rovings are generally evenly distributed throughout the tape 56. In these embodiments, the rovings may be generally indistinguishable from each other. Referring to FIGS. 15 and 16, for example, embodiments of a tape 56 are shown that contains rovings that are combined such that the fibers 216 are generally evenly distributed therein. As shown in FIG. 15, in exemplary embodiments, the fibers extend generally unidirectionally, such as along a longitudinal axis of the tape 56.

Through use of apparatus and methods according to the present disclosure and control over the various parameters mentioned above, having a very high strength may be formed. For example, the tapes may exhibit a high maximum load. Maximum load may be determined according to ASTM D3039. The maximum load may be, for example, greater than about 290 pounds per square inch (psi), or for example greater than about 130 kilograms per square inch (130 ksi).

The tapes may exhibit a relatively high flexural modulus. The term “flexural modulus” generally refers to the ratio of stress to strain in flexural deformation (units of force per area), or the tendency for a material to bend. It is determined from the slope of a stress-strain curve produced by a “three point flexural” test (such as ASTM D790-10, Procedure A), typically at room temperature. For example, the tapes of the present disclosure may exhibit a flexural modulus of from about 10 Gigapascals (“GPa”) or more, in some embodiments from about 12 to about 400 GPa, in some embodiments from about 15 to about 200 GPa, and in some embodiments, from about 20 to about 150 GPa. Furthermore, the ultimate tensile strength may be about 300 Megapascals (“MPa”) or more, in some embodiments from about 400 MPa to about 5,000 MPa, and in some embodiments, from about 500 MPa to about 3,500 MPa. The term “ultimate tensile strength” generally refers to the maximum stress that a material can withstand while being stretched or pulled before necking and is the maximum stress reached on a stress-strain curve produced by a tensile test (such as ASTM D3916-08) at room temperature. The tensile modulus of elasticity may also be about 50 GPa or more, in some embodiments from about 70 GPa to about 500 GPa, and in some embodiments, from about 100 GPa to about 300 GPa. The term “tensile modulus of elasticity” generally refers to the ratio of tensile stress over tensile strain and is the slope of a stress-strain curve produced by a tensile test (such as ASTM 3916-08) at room temperature. Notably, the strength properties of the composite tapes referenced above may also be maintained over a relatively wide temperature range, such as from about −40° C. to about 300° C., and particularly from about 180° C. to 200° C.

Tapes made according to the present disclosure may further have relatively high flexural fatigue life, and may exhibit relatively high residual strength. Flexural fatigue life and residual flexural strength may be determined based on a “three point flexural fatigue” test (such as ASTM D790, typically at room temperature. For example, the tapes of the present disclosure may exhibit residual flexural strength after one million cycles at 160 Newtons (“N”) or 180 N loads of from about 60 kilograms per square inch (“ksi”) to about 115 ksi, in some embodiments about 70 ksi to about 115 ksi, and in some embodiments about 95 ksi to about 115 ksi. Further, the tapes may exhibit relatively minimal reductions in flexural strength. For example, tapes having void fractions of about 4% or less, in some embodiments about 3% or less, may exhibit reductions in flexural strength after three point flexural fatigue testing of about 1% (for example, from a maximum pristine flexural strength of about 106 ksi to a maximum residual flexural strength of about 105 ksi). Flexural strength may be tested before and after fatigue testing using, for example, a three point flexural test as discussed above.

The linear thermal expansion coefficient of the composite tapes may be, on a ppm basis per ° C., less than about 5, less than about 4, less than about 3, or less than about 2. For instance, the coefficient (ppm/° C.) may be in a range from about −0.25 to about 5; alternatively, from about −0.17 to about 4; alternatively, from about −0.17 to about 3; alternatively, from about −0.17 to about 2; or alternatively, from about 0.29 to about 1.18. The temperature range contemplated for this linear thermal expansion coefficient may be generally in the −50° C. to 200° C. range, the 0° C. to 200° C. range, the 0° C. to 175° C. range, or the 25° C. to 150° C. range. The linear thermal expansion coefficient is measured in the longitudinal direction, i.e., along the length of the fibers.

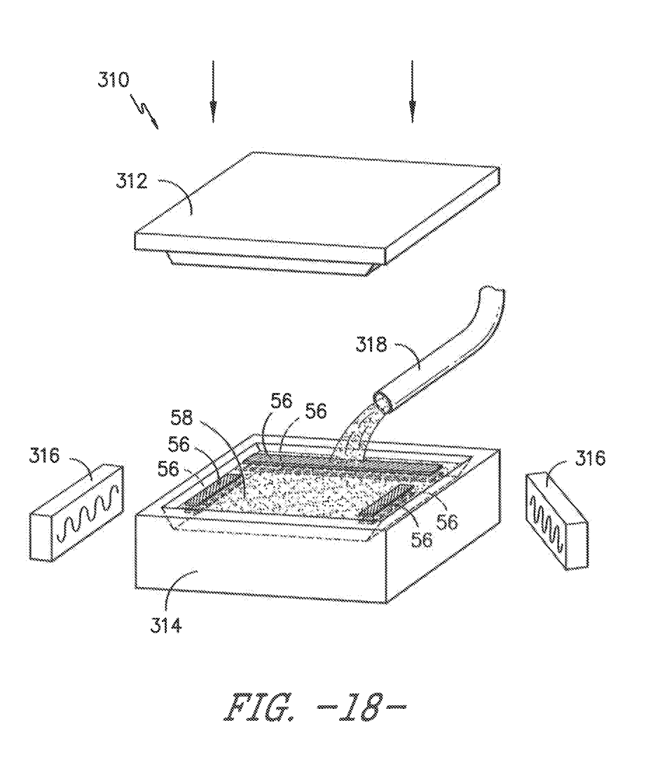

Referring now to FIGS. 17 through 19, apparatus for forming composite members 50 in accordance with various embodiments of the present disclosure are illustrated. FIG. 17 illustrates a mold 300 for, for example, thermoforming a composite member 50. In this embodiment, the base member 52 is initially formed, and one or more tapes 56 are then bonded to the outer surface 54 of the base member 52. The mold 300 includes a negative mold portion 302 and a positive mold portion 304. The mold 300 may further include one or more heating devices 306, which may be separate components from the mold portions 302, 304 or integral with one or both mold portions 302, 304. The base member 52 may be positioned on the negative mold portion 302, and the tape(s) 56 may be positioned on the outer surface 54 of the base member 52. The tape(s) 56 and base member 52 may then be heated, such as to a temperature wherein the materials thereof are pliable, such as a melting temperature. Additionally or alternatively, the tape(s) 56 and base member 52 may be pressed together, such as by moving the positive mold portion 304 towards the negative mold portion 302, or vice versa, or by moving both portions 302, 304 towards each other. Such application of pressure may be generally constantly applied by the mold 300. The combination of heating and pressing may cause the tape(s) 56 to bond with the base member 52, such as with the outer surface 54 thereof, forming the composite member 50.

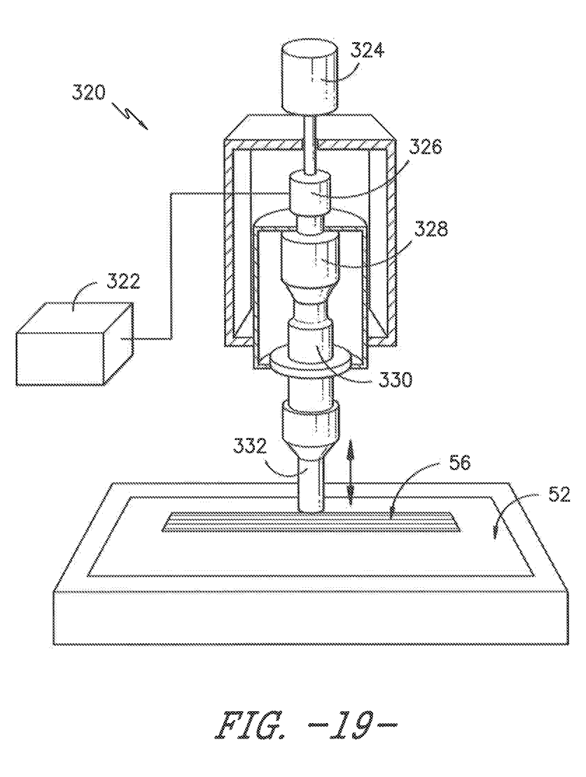

FIG. 18 illustrates a mold 310 for, for example, compression molding composite member 50. In this embodiment, the base member 52 is formed during molding of the member 50. The tape(s) 56 may be bonded to the outer surface 54 of the resulting base member 52, and/or may be disposed and bonded within the resulting base member 52. The mold 310 includes an upper mold portion 312 and a lower mold portion 314. The mold 310 may further include one or more heating devices 316, which may be separate components from the mold portions 312, 314 or integral with one or both mold portions 312, 314. The polyethylene material that forms the base member 52 may be positioned in the lower mold portion 312. For example, in exemplary embodiments, the polyethylene material is a polyethylene powder 58, which may be poured into lower mold portion 312 from a dispenser 318. The tape(s) 56 may additionally be positioned in the mold 310, such as in the lower mold portion 312. The tape(s) 56 and powder 58 may then be heated, such as to a temperature wherein the materials thereof are pliable, such as a melting temperature. Additionally or alternatively, the tape(s) 56 and powder 58 may be pressed together, such as by moving the upper mold portion 314 towards the lower mold portion 312, or vice versa, or by moving both portions 312, 314 towards each other. Such application of pressure may be generally constantly applied by the mold 300. The combination of heating and pressing may cause the powder 58 to form into the base member 52, and the tape(s) 56 to bond on or within the resulting base member 52, forming the composite member 50.

It should be noted that, in embodiments wherein the tape(s) 56 are bonded to an already formed base member 52, the base member 52 may be initially formed using any suitable methods and apparatus. In one embodiment, for example, the base member 52 may be initially compression molded from powder 58 in a mold 310, as illustrated and discussed above, with no tape(s) utilized in the mold 310 during this initial forming.

Notably, one or more layers of tapes 56 and base members 52 may be utilized to form a composite member 50, as illustrated and as shown for example in FIGS. 17 and 18. For example, FIG. 17 illustrates multiple layers of tapes 56 being bonded to a base member 52. FIG. 18 illustrates a first layer of tapes 56, a first layer of powder 58 on this first layer of tapes 56, a second layer of tapes 56 on the first layer of powder 58, and a second layer of powder 58 being poured onto the second layer of tapes 56. Any suitable arrangement any layering of tapes 56 and base members 52 or powder 58 to form the base members 52 is within the scope and spirit of the present disclosure.

FIG. 19 illustrates a welding device 320 for bonding a tape 56 to a base member 52. In exemplary embodiments, one or more tapes 56 may thus be bonded to a base member 52 by welding. The welding device 320 as illustrated is an ultrasonic welding device. The welding device 320 thus includes a power source 322, pneumatic piston 324, transducer 326, converter 328, booster 330, and horn 332. Piston 324 may generally hold the materials to be welded together. The power source 322 generally supplies high frequency electricity to the transducer 326 and/or converter 328, which convert this electricity to high-frequency sound. Booster 330 increases vibrations from the sound, and horn 332 focuses these ultrasonic vibrations and delivers them to the material to be welded; in this case, one or more tape 56 layers and one or more base members 52. The application of ultrasonic vibrations may heat the tape 56 layers and base members 52 and repeatedly press the tape 56 layers and base members 52 together, bonding them together.

It should be understood that the present disclosure is not limited to ultrasonic welding. Rather, any suitable welding technique, and the corresponding welding device or apparatus, may be utilized. For example, linear vibration welding, orbital friction welding, thermal welding, and other suitable welding techniques are within the scope and spirit of the present disclosure.

Notably, welding may be utilized as a stand-alone process for bonding tapes 56 to a base member 52, or may be utilized as an initial process for such bonding. For example, welding may be utilized to initially bond tapes 56 to a base member 52, and the tapes 56 and base member 52 may then be further processed, such as via thermoforming, etc., to further bond the tapes 56 to the base member 52 and form the composite member 50.

It should further be understood that the present disclosure is not limited to thermoforming, compression molding and welding. Additional examples of apparatus and methods for forming composite members 50 in accordance with the present disclosure include pressing in a static mold, injection molding, and any other suitable methods and apparatus.

As mentioned, the present disclosure is further directed to methods for forming composite members 50. A method may include, for example, forming a base member 52 from a polyethylene material, as discussed herein, and bonding a tape 56 to the base member 52, as discussed herein.

In some embodiments, the bonding step may include, for example, positioning the tape 56 on an outer surface 54 of the base member 52. Further, the bonding step may include, for example, heating the tape 56 and base member 52, as discussed herein. Additionally or alternatively, the bonding step may include, for example, applying a generally constant pressure to the tape 56 and base member 52, as discussed herein. For example, such heating and pressing may be performed through thermoforming, or compressing molding. Additionally or alternatively, the bonding step may include, for example, or welding the tape 56 to the base member 52. The welding step may in some embodiments include applying ultrasonic vibrations to the tape 56 to the base member 52, or alternatively may include other suitable welding steps.

In some embodiments, the forming step and the bonding step may occur simultaneously. Further, the method may additionally include, for example, positioning the tape 52 in a mold 310, as discussed herein, and introducing the polyethylene material into the mold 310, as discussed herein.

In some embodiments, a method may further include the step of forming the tape 56 from a fiber reinforced thermoplastic material. The forming step may include, for example, flowing a resin 214 through a manifold assembly 220 of a die 150, the manifold assembly 220 comprising a plurality of branched runners 222, as discussed herein. The forming step may further include, for example, coating at least one fiber roving 142 with the resin 214, as discussed herein. The forming step may further include, for example, traversing the coated roving 142 through an impregnation zone 250 of the die 150 to impregnate the roving 142 with the resin 214, as discussed herein.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A composite member, comprising:
a base member, the base member formed from a polyethylene; and
a tape bonded to the base member, the tape formed from a fiber reinforced thermoplastic material, the fiber reinforced thermoplastic material comprising a plurality of fibers dispersed in a polyethylene resin.

2. The composite member of claim 1, wherein the polyethylene forming the base member is one of a high molecular weight polyethylene, a very-high molecular weight polyethylene, or an ultra-high molecular weight polyethylene.

3. The composite member of claim 1, wherein the polyethylene resin is a high density polyethylene.

4. The composite member of claim 1, wherein the fibers are one of glass fibers, carbon fibers or aramid fibers.

5. The composite member of claim 1, wherein the fibers are continuous fibers.

6. The composite member of claim 5, wherein the continuous fibers are generally unidirectional.

7. The composite member of claim 1, wherein the tape is bonded to an outer surface of the base member.

8. The composite member of claim 1, wherein the tape is disposed within the base member.

9. The composite member of claim 1, wherein the tape provides local reinforcement to the base member.

10. The composite member of claim 1, wherein the base member is a semi-finished good.

11. The composite member of claim 1, wherein the tape is a plurality of tapes.

12. The composite member of claim 11, wherein at least a portion of the plurality of tapes are arranged as a plurality of tape layers.

13. A method for forming a composite member, the method comprising:
forming a base member from a polyethylene material; and
bonding a tape to the base member, the tape formed from a fiber reinforced thermoplastic material, the fiber reinforced thermoplastic material comprising a plurality of fibers dispersed in a thermoplastic resin.

14. The method of claim 13, wherein the bonding step comprises:
positioning the tape on an outer surface of the base member; and
heating the tape and base member.

15. The method of claim 13, wherein the bonding step comprises:
positioning the tape on an outer surface of the base member; and
applying a generally constant pressure to the tape and base member.

16. The method of claim 13, wherein the forming step and the bonding step occur simultaneously, and further comprising the steps of:
positioning the tape in a mold; and
introducing the polyethylene material into the mold.

17. The method of claim 16, wherein the polyethylene material is a polyethylene powder.

18. The method of claim 13, wherein the bonding step comprises welding the tape to the base member.

19. The method of claim 18, wherein the welding step comprises applying ultrasonic vibrations to the tape and the base member.

20. The method of claim 13, further comprising the step of forming the tape from the fiber reinforced thermoplastic material, wherein the forming step comprises:
flowing the polyethylene resin through a manifold assembly of a die, the manifold assembly comprising a plurality of branched runners;
coating at least one fiber roving with the resin, the at least one fiber roving comprising the plurality of fibers; and
traversing the coated roving through an impregnation zone of the die to impregnate the roving with the resin.

21. The method of claim 13, wherein the polyethylene forming the base member is one of a high molecular weight polyethylene, a very-high molecular weight polyethylene, or an ultra-high molecular weight polyethylene.

22. The method of claim 13, wherein the thermoplastic resin is a polyethylene resin.

23. The method of claim 22, wherein the polyethylene resin is a high density polyethylene.

24. The method of claim 13, wherein the fibers are one of glass fibers, carbon fibers or aramid fibers.
